(19) United States
(12) Patent Application Publication
(10) Pub. No.: US 2020/0354537 A1
(43) Pub. Date: Nov. 12, 2020

(54) CYCLIC OLEFIN COPOLYMER COMPOSITIONS FOR FOAM APPLICATIONS

(71) Applicants: ExxonMobil Chemical Patents Inc., Houston, TX (US); The University of Vermont and State Agricultural College, Burlington, VT (US)

(72) Inventors: Carlos Lopez-Barron, Houston, TX (US); Yong Yang, Houston, TX (US); Patrick C. Lee, Etobicoke (CA); Hee Eon Park, Christchurch (NZ); Sandra Diez, Toronto (CA)

(21) Appl. No.: 16/409,596

(22) Filed: May 10, 2019

(51) Int. Cl. C08J 9/12; C08J 9/14

(52) U.S. Cl. CPC C08J 9/122; C08J 9/141; C08J 9/145; C08J 9/144; C08J 2203/08; C08J 2323/08; C08J 2203/142; C08J 2205/052; C08J 2205/10; C08J 2345/00; C08J 2203/06

(57) ABSTRACT

The present application provides a foam including a cyclic olefin copolymer containing cyclic olefin monomer units in an amount from about 0.5 mol. % to about 50 mol. % based on the total amount of monomers in the polymer, and methods of making such a foam.

### TECHNICAL FIELD

This disclosure relates to compositions containing polymers with cyclic olefin monomer units, and to methods for producing foams from the polymer compositions.

### BACKGROUND

There is a large and growing market for polymer foams. Examples of such foams include polyurethane foams and polystyrene foams. These foams are commonly used in the construction, packaging, auto, and comfort industries.

### SUMMARY

Foams made from cyclic olefin copolymers (COCs) described in the present disclosure can be relatively light, inexpensive, and/or easy to recycle as compared to polyurethane and polystyrene-based foams. Cyclic olefin copolymer blends of the present disclosure can exhibit strong extensional strain hardening and melt strength, which can provide for excellent foamability and/or resultant foam stability. The foams typically have a high expansion ratio (a low density), a high cell count, and a high closed cell content. The foams can be rigid or resilient, as desired, depending, for example, on the content of the cyclic olefin monomer units. The foams of the present disclosure can demonstrate favorable inflammability and low thermal conductivity properties, making them suitable for construction and insulation applications.

In a first general aspect, this disclosure provides a method including (i) combining a polymer with a foaming agent to produce a composition, and (ii) foaming the composition to produce a foam. The polymer contains cyclic olefin monomer units in an amount from about 0.5 mol. % to about 50 mol. % based on the total amount of monomer units in the polymer.

In a second general aspect, this disclosure provides a composition, which is a foam, and includes a polymer containing cyclic olefin monomer units in an amount from about 0.5 mol. % to about 50 mol. % based on the total amount of monomer units in the polymer. Optionally, the foam includes a foaming agent.

In a third general aspect, the present disclosure provides a foam including a polymer containing cyclic olefin monomer units in an amount from about 0.5 mol. % to about 50 mol. % based on the total amount of monomer units in the polymer, made by a method of the first general aspect.

Certain aspects of the first, second, and third general aspects may include one or more of the following features.

In some aspects, the polymer includes cyclic olefin monomer units in an amount from about 1 mol. % to about 30 mol. % based on the total amount of monomer units in the polymer.

In some aspects, the cyclic olefin monomer is a norbornene, a tetracyclododecene, a cyclopentene, a dicyclopentadiene, a cyclooctene, and/or a cyclooctadiene. Examples of a norbornene include an ethylidene norbornene and a vinyl norbornene.

In some aspects, the polymer contains at least one ethylene monomer.

In some aspects, the polymer contains at least one α-olefin monomer that is 1-propene, 1-butene, 1-hexene, or 1-octene.

In some aspects, the polymer is branched.

In some aspects, the polymer contains a monomer containing a polar functional group.

In some aspects, the polar functional group is a hydroxy, an aldehyde, an acid, an amine, an amide, an anhydride, and/or a urea.

In some aspects, the polymer is amorphous.

In some aspects, the polymer is semi-crystalline.

In some aspects, the polymer has one or more of the following properties: a highest glass-transition temperature (T_{g}) of from about −80° C. to about 80° C. at atmospheric pressure; a melting temperature (Tₘ) of from about 30° C. to about 120° C. at atmospheric pressure; and a melt index, measured at 230° C./2.16 kg, of from about 0.1 g/min to about 50 g/min at atmospheric pressure.

In some aspects, the foaming agent includes a liquefied gas.

In some aspects, the foaming agent includes carbon dioxide, nitrogen, a hydrocarbon, and/or a chlorofluorocarbon.

In some aspects, the hydrocarbon is propane, butane, propene, butene, isobutene, pentane, hexane, and/or heptane.

In some aspects, the chlorofluorocarbon is trichloethylene, dichloroethane, trichlorofluoromethane, dichlorodifluoromethane, 1,2,2-thrichlorothrifluoroehtane, and/or dichlorotetrafluoroethane.

In some aspects, combining the polymer with a foaming agent to produce the composition is performed at a pressure of from about 500 psig (3,450 kPag) to about 4,000 psig (27,580 kPag).

In some aspects, combining a polymer with a foaming agent to produce a composition is performed at or above the melting temperature of the polymer.

In some aspects, the foaming agent is soluble in the polymer.

In some aspects, the composition is a homogenous liquid.

In some aspects, foaming the composition to produce the foam is performed using a pressure-drop technique to foam the composition.

In some aspects, the foam has one or more of the following properties: a density of from about 0.1 g/cm³ to about 0.7 g/cm³; a closed cell content of at least 50%; a thermal diffusivity from about 0.1 mm²/s to about 0.3 mm²/s; and a specific heat value of from about 0.2 MJ/m³K to about 0.4 MJ/m³K.

In some aspects, the foam is rigid.

In some aspects, the foam is resilient.

Unless otherwise defined, all technical and scientific terms used herein have the same meaning as commonly understood by one of ordinary skill in the art to which the present application belongs. Methods and materials are described herein for use in the present application; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control. Other features and advantages of the present application will be apparent from the following detailed description and figures, and from the claims.

### DESCRIPTION OF DRAWINGS

FIG. 1 contains dynamical mechanical analysis of TOPAS™ Elastomer E-140 (TOPAS™ E-140) COC.

FIG. 2 contains a line plot showing complex shear viscosity of TOPAS™ E-140 COC as a function of frequency measured at 80° C.

FIG. 3 contains a line plot showing transient extensional viscosity of TOPAS™ E-140 COC measured at the indicated temperatures.

FIG. 4 contains micrographs of TOPAS™ E-140 COC foams prepared at different processing conditions.

FIG. 5 contains photographs of TOPAS™ E-140 COC foams prepared at different processing conditions.

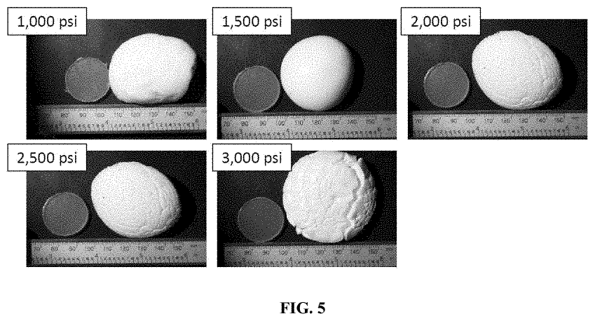

FIG. 6 contains a line plot showing foam density and volume expansion ratio of COC foams as a function of CO₂ pressure (circles show the values of volume expansion ratio and squares show the values of foam density).

FIG. 7 contains a line plot showing foam density comparison between foams prepared from commercial polypropylene (DAPLOY™ WB 140) and COC (TOPAS™ E140).

FIG. 8 contains a line plot showing cell density and cell count of COC foams as a function of CO₂ pressure (circles show the values of for cell density and squares show the values of cell count).

FIG. 9 contains a line plot showing cell density comparison between foams prepared from COC (TOPAS™ E140), polypropylene (DAPLOY™ WB 140), and linear low density polyethylene (LLDPE) (TUFLIN™ HES-1003 NT 7).

FIG. 10 contains a line plot showing closed cell content of COC foams as a function of CO₂ pressure.

FIG. 11 contains a line plot showing burning time of COC foams as a function of CO₂ pressure.

FIG. 12 contains a line plot showing crystallization temperature of various COC samples under atmospheric pressure and CO₂ pressure.

FIG. 13 contains a line plot showing melting temperature of various COC samples under atmospheric pressure and CO₂ pressure.

FIG. 14 contains a table showing comparison of degree of crystallinity of COC and propylene polymer material.

### DETAILED DESCRIPTION

In a general aspect, the disclosure provides various methods of making a foam. One example of such a method includes combining a polymer with a foaming agent to produce a composition (e.g., foamable composition), and then foaming the composition to produce a foam. In some aspects of this method, the polymer is a cyclic olefin copolymer (COC).

In other general aspects, the disclosure provides compositions, which are foams. One example of such a composition includes a composition (e.g., a foam) including a polymer containing cyclic olefin monomer units. Another example of such a composition includes a composition prepared by any one of the processes of the present disclosure.

In some aspects, the cyclic olefin copolymer includes cyclic olefin monomer units in an amount of from about 0.5 mol. % to about 50 mol. % based on the total amount of monomer units in the copolymer. For example, the cyclic olefin copolymer can include from about 1 mol. % to about 30 mol. %, from about 1 mol. % to about 20 mol. %, from about 1 mol. % to about 10%, from about 5 mol. % to about 15 mol. %, from about 5 mol. % to about 25 mol. %, or from about 10 mol. % to about 35 mol. % of the cyclic olefin monomer units. In some aspects, the cyclic olefin copolymer includes about 1 mol. %, about 5 mol. %, about 8 mol. %, about 10 mol. %, about 11 mol. %, about 15 mol. %, or about 20 mol. % of the cyclic olefin monomer units.

In some aspects, the cyclic olefin copolymer includes cyclic olefin monomer units in an amount from about 1 wt. % to about 50 wt. % based on the total weight of the copolymer. For example, the cyclic olefin copolymer can include from about 5 wt. % to about 45 wt. %, from about 5 wt. % to about 40%, from about 5 wt. % to about 30 wt. %, from about 10 wt. % to about 35 wt. %, or from about 15 wt. % to about 25 wt. % of the cyclic olefin monomer units based on the total weight of the copolymer. In some aspects, the cyclic olefin copolymer includes about 5 wt. %, about 10 wt. %, about 15 wt. %, about 20 wt. %, about 25 wt. %, about 30 wt. %, or about 40 wt. % of the cyclic olefin monomer units.

In some aspects, the cyclic olefin monomer has the formula:

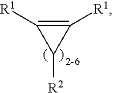

wherein each IV is independently selected from H and C₁₋₆ alkyl; and each R² is independently selected from H, C₁₋₆ alkyl, C₁₋₆ alkenyl, and C₁₋₆ alkylidene. In the alternative, any two R² together with the carbon atoms to which they are attached from a C₃₋₈ cycloalkyl ring or C₃₋₈ cycloalkenyl ring, each of which is optionally substituted with 1 or 2 R²; or any two R², when attached to adjacent carbon atoms, form a bond (i.e., there is a double bond between the two adjacent carbon atoms).

Suitable examples of cyclic olefin monomers include norbornene, tetracyclododecene, cyclopentene, dicyclopentadiene, cyclooctene, and cyclooctadiene. Suitable examples of norbornenes include bicyclo[2.2.1]hept-2-ene, ethylidene norbornene, and vinyl norbornene.

In some aspects, the cyclic olefin monomer is selected from any one of the following compounds:

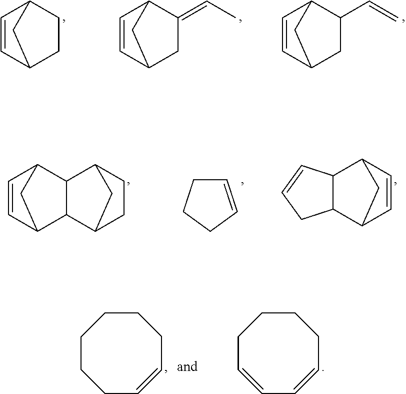

In some aspects, the cyclic olefin monomer is a norbornene of formula

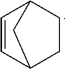

In some aspects, the cyclic olefin copolymer includes at least one ethylene monomer unit. In such aspects, the cyclic olefin copolymer can include ethylene monomer units in an amount from about 50 mol. % to about 95 mol. % based on the total amount of monomer units in the copolymer. For example, the cyclic olefin copolymer can include from about 80 mol. % to about 99 mol. %, from about 90 mol. % to about 99%, from about 85 mol. % to about 95 mol. %, from about 75 mol. % to about 95 mol. %, or from about 65 mol. % to about 90 mol. % of the cyclic olefin monomer units. In some aspects, the cyclic olefin copolymer includes about 99 mol. %, about 95 mol. %, about 92 mol. %, about 90 mol. %, about 89 mol. %, about 85 mol. %, or about 80 mol. % of the cyclic olefin monomer units.

In some aspects, the cyclic olefin copolymer includes ethylene monomer units in an amount from about 50 wt. % to about 99 wt. % based on the total weight of the copolymer. For example, the cyclic olefin copolymer can include from about 55 wt. % to about 95%, from about 60 wt. % to about 95 wt. %, from about 70 wt. % to about 95 wt. %, or from about 65 wt. % to about 90 wt. % of ethylene monomer units based on the total weight of the copolymer. In some aspects, the cyclic olefin copolymer can include about 95 wt. %, about 90 wt. %, about 85 wt. %, about 80 wt. %, about 75 wt. %, about 70 wt. %, or about 60 wt. % of ethylene monomer units.

In some aspects, the cyclic olefin copolymer includes at least one α-olefin monomer. Suitable examples of an α-olefin monomer include 1-propene, 1-butene, 1-hexene, and 1-octene. In one example, the cyclic olefin copolymer includes an α-olefin monomer units in an amount from about 1 mol. % to about 5 mol. %, or from about 1 mol. % to about 10 mol. % based on the total amount of monomer units in the copolymer. In another example, the cyclic olefin copolymer can include α-olefin monomer units in an amount from about 1 wt. % to about 10 wt. %, or from about 1 wt. % to about 20 wt. % of the α-olefin monomer units based on the total weight of the copolymer.

The cyclic olefin copolymer can be branched or linear. For example, the cyclic olefin copolymer can have from 2 to 100 termini (e.g., 2 to 80, 2 to 75, 2 to 60, 2 to 50, 2 to 40, 2 to 35, 2 to 25, 2 to 10, 2 to 5, 4 to 20, 5 to 25, 10 to 50, 25 to 75, 3 to 6, 5 to 15 termini). In some aspects, the cyclic olefin copolymer is branched and has from 3 to 5, 4 to 6, 5 to 6, or 3 to 6 termini. In some aspects, the cyclic olefin copolymer is linear and therefore has 2 termini.

The weight-average molecular weight (M_{W}) of the cyclic olefin copolymer can be between about 1,000 Da and about 250,000 Da. For example, the cyclic olefin copolymer can have an M_{w} of about 200,000 Da, about 195,000 Da, about 190,000 Da, about 185,000 Da, about 180,000 Da, about 175,000 Da, about 170,000 Da, about 165,000 Da, about 160,000 Da, about 155,000 Da, about 150,000 Da, about 145,000 Da, about 140,000 Da, about 135,000 Da, about 130,000 Da, about 125,000 Da, about 120,000 Da, about 115,000 Da, about 100,000 Da, about 90,000 Da, about 80,000 Da, about 70,000 Da, about 60,000 Da, about 50,000 Da, about 40,000 Da, about 30,000 Da, about 20,000 Da, and about 10,000 Da. The polydispersity index (PDI) (M_{w}/Mₙ) of the cyclic olefin copolymer can be between about 1.50 and about 3.00. For example, the cyclic olefin copolymer can have a PDI of about 2.95, about 2.90, about 2.85, about 2.80, about 2.75, about 2.70, about 2.65, about 2.60, about 2.55, about 2.50, about 2.45, about 2.40, about 2.35, about 2.30, about 2.25, about 2.20, about 2.15, about 2.10, about 2.05, about 2.00, about 1.90, about 1.80, about 1.70, about 1.60, or about 1.50.

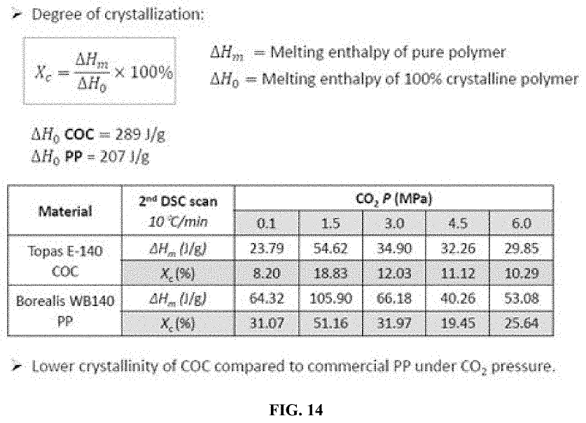

In some aspects, the cyclic olefin copolymer is amorphous. As used herein, the term “amorphous” refers to a solid polymer composition in which the arrangement of polymer molecules is random and lacks the order characteristic of a crystal. In certain aspects, the cyclic olefin copolymer is semi-crystalline. As used herein, the term “semi-crystalline” refers to a solid polymer composition containing areas of crystallinity, in which the polymer material exhibits organized and tightly packed molecular chains. For example, crystallinity of the polymer is from about 1% to about 20%, from about 5% to about 15%, or from about 10% to about 40%. The crystallinity of a polymer sample may be determined, for example, as a ratio of melting enthalpy of the polymer sample to the melting enthalpy of fully crystalline polymer, wherein the melting enthalpies are determined using high pressure differential scanning calorimeter (HP-DSC) analysis. An exemplary method of determining crystallinity of a polymer sample is shown in FIG. 14.

The crystallinity temperature of the cyclic olefin copolymer may be from about 40° C. to about 80° C., or from about 50° C. to about 70° C., as measured at atmospheric pressure using, for example, DSC analysis. The highest glass-transition temperature of the cyclic olefin copolymer may be from about −80° C. to about 80° C., or from about −20° C. to about 20° C., as measured at atmospheric pressure, using, for example, DSC analysis. The glass transition temperature was determined as the temperature where an inflexion point in the heat flow signal is detected during the second heating in the DSC analysis. The melting temperature of the cyclic olefin copolymer may be from about 30° C. to about 120° C., or from about 60° C. to about 120° C., as measured at atmospheric pressure using, for example, DSC analysis. The melt index (or melt flow index, MFI) of the cyclic olefin copolymer, measured at 230° C./2.16 kg and atmospheric pressure, can be from about 0.1 g/min to about 50 g/min, from about 0.1 g/min to about 25 g/min, from about 0.1 g/min to about 10 g/min, from about 0.1 g/min to about 5 g/min, or from about 0.1 g/min to about 1 g/min. The MFI is a measure of the ease of the flow of the melt of a thermoplastic polymer. In some aspects, the density of the cyclic olefin copolymer is from about 0.8 g/cm³ to about 1 g/cm³, measured at atmospheric pressure, for example, by dividing mass of the polymer sample by its volume. For example, the density of the cyclic olefin copolymer is about 0.8 g/cm³, about 0.85 g/cm³, about 0.9 g/cm³, or about 0.95 g/cm³. In some aspects, the viscosity of the cyclic olefin copolymer, measured at about its melting temperature and atmospheric pressure, is from about 100 kPa×s to about 500 kPa×s, as measured at atmospheric pressure using, for example, rheological analysis. For example, viscosity of the cyclic olefin copolymer is about 100 kPa×s, about 150 kPa×s, about 200 kPa×s, about 250 kPa×s, or about 300 kPa×s.

In some aspects, the cyclic olefin copolymer has one or more of the following properties: a highest glass-transition temperature of from about −80° C. to about 80° C. at atmospheric pressure; a melting temperature of from about 30° C. to about 120° C. at atmospheric pressure; and a melt index, measured at 230° C./2.16 kg and atmospheric pressure, of from about 0.1 g/min to about 50 g/min.

In some aspects, the following holds: the cyclic olefin copolymer is a branched polyethylene containing norbornene monomer units; the amount of norbornene monomer units is from about 1 mol. % to about 20 mol. % based on the total amount of monomer units in the cyclic olefin copolymer; the cyclic olefin copolymer is amorphous or semi-crystalline with crystallinity from about 10% to about 35% the crystallinity temperature of the cyclic olefin copolymer is from about 50° C. to about 70° C. at atmospheric pressure; the highest glass-transition temperature of the cyclic olefin copolymer is from about −10° C. to about 10° C. at atmospheric pressure; the melting temperature of the cyclic olefin copolymer is from about 60° C. to about 120° C. at atmospheric pressure; the density of the cyclic olefin copolymer is from about 0.8 g/cm³ to about 1 g/cm³ at atmospheric pressure; the melt index of the cyclic olefin copolymer, measured at 230° C./2.16 kg and atmospheric pressure, is from about 0.1 g/min to about 0.3 g/min; and the viscosity of the cyclic olefin copolymer, measured at about its melting temperature and atmospheric pressure, is from about 200 kPa×s to about 400 kPa×s.

In some aspects, the cyclic olefin copolymer is any one of the cyclic olefin copolymers described in U.S. Pat. No. 9,982,081 or US patent publication No. 2018/0291128, which are incorporated herein by reference in their entirety. The cyclic olefin copolymer can be prepared by any one of the processes described in these documents. In one example, the cyclic olefin copolymer can be produced by a gas-phase polymerization process using a heterogeneous catalyst. In another example, the cyclic olefin copolymer can be produced by a solution polymerization process. Suitable examples of polymerization catalysts include Group 4 metallocenes.

In some aspects, the cyclic olefin copolymer contains at least one monomer containing a polar functional group. Suitable examples of such polar functional groups include hydroxy, aldehyde, acid, amine, amide, anhydride, and urea. Without being bound by any theory, it is believed that polar functional groups in the cyclic olefin copolymer, containing heteroatoms such as N, O, and S, decrease overall hydrophobicity of the copolymer and subsequently increase miscibility of the copolymer with polar foaming agents, such as liquefied nitrogen gas, chlorocarbons, and fluorocarbons.

The cyclic olefin copolymers of this disclosure can possess one or more of numerous advantageous properties. Examples of such properties include good processability, high elasticity, toughness, stiffness, strength, and increased strain hardening.

In some aspects, the cyclic olefin copolymer may be combined with at least one foaming agent. Suitable examples of foaming agents include chemical blowing agents, aliphatic hydrocarbons, aliphatic alcohols, and chlorinated and fluorinated hydrocarbons (chlorofluorocarbons). As used herein, the term “chemical blowing agents” refers to organic and inorganic chemical compounds that chemically react or decompose to release foaming gas or vapor. Suitable examples of organic chemical blowing agents include azodicarbonamide, azodiisobutyronitrile, benzenesulfonyl hydrazide, 4,4-oxybenzenesulfonylsemicarbazide, p-toluenesulfonyl semicarbazide, barium azodicarboxylate, N,N′-dimethyl-N,N′-dinitrosoterephthalamide, trihydrazinotriazine, N,N′-dimethyl-N,N′-dinitrosoterephthalamide and N,N′-dinitrosopentamethylene tetramine, azodicarbonamide, azobisisobutylonitrile, azocyclohexyl nitrile, azodiaminobenzene, benzenesulfonyl hydrazide, toluenesulfonyl hydrazide, p,p′-oxybis(benzenesulfonyl hydrazide), and diphenylsulfone-3,3′-disulfonylhydrazide, 4,4′-diphenyldisulfonyl azide, and p-toluenesulfonyl azide. Suitable examples of inorganic blowing agents include sodium bicarbonate, sodium carbonate, ammonium bicarbonate, ammonium carbonate, ammonium nitrite, barium azodicarboxylate, and calcium azide. Suitable examples of aliphatic hydrocarbons include methane, ethane, propane, n-butane, propene, butene, isobutene, isobutane, n-pentane, isopentane, neopentane, hexane, and heptane. Suitable examples of aliphatic alcohols include methanol, ethanol, n-propanol, and isopropanol. Suitable examples of chlorinated and fluorinated hydrocarbons include methyl fluoride, perfluoromethane, ethylfluoride, 1,1-difluoroethane (HFC-152a), 1,1,1-trifluoroethane (HFC-143a), 1,1,1,2-tetrafluoroethane (HFC-134a), pentafluoroethane, perfluoroethane, 2,2-difluoropropane, 1,1,1-trifluoropropane, perfluoropropane, perfluorobutane, perfluorocyclobutane, methyl chloride, methylene chloride, ethyl chloride, 1,1,1-trichloroethane, 1,1-dichloro-1-fluoroethane (HCFC-141b), 1-chloro-1,1-difluoroethane (HCFC-142b), 1,1-dichloro-2,2,2-trifluoroethane (HCFC-123), 1-chloro-1,2,2,2-tetrafluoroethane (HCFC-124), trichloromonofluoromethane (CFC-11), dichlorodifluoromethane (CFC-12), trichlorotrifluoroethane (CFC-113), dichlorotetrafluoroethane (CFC-114), chloroheptafluoropropane, trichloethylene, dichloroethane, trichlorofluoromethane, 1,2,2-thrichlorothrifluoroehtane, and dichlorohexafluoropropane. In some aspects, the foaming agent is selected from carbon dioxide (CO₂), argon, water, air, nitrogen, and helium. The foaming agent may be a liquefied gas. That is, the foaming agent may be a gas at atmospheric pressure, but may be turned into a liquid. This may be accomplished by cooling the gas or by compressing the gas at a pressure sufficient to turn it into a liquid. In some aspects, the foaming agent is a liquefied gas that has been compressed at a pressure that is about 2 times, about 4 times, about 10 times, about 50 times, about 100 times, about 200 times, or about 300 times greater than atmospheric pressure.

The foaming agent is typically added to the foaming composition in an amount sufficient to make a foam. In one example, an amount of foaming agent is from about 1 wt. % to about 90 wt. %, from about 1 wt. % to about 75 wt. %, from about 1 wt. % to about 50 wt. %, from about 1 wt. % to about 25 wt. %, from about 1 wt. % to about 10 wt. %, from about 1 wt. % to about 5 wt. %, from about 5 wt. % to about 75 wt. %, from about 5 wt. % to about 50 wt. %, or from about 5 wt. % to about 25 wt. % of the total weight of the composition. In some aspects, the amount of foaming agent is sufficient to diffuse into the cyclic olefin copolymer to produce a homogenous composition. The amount of foaming agent in the composition can be altered to obtain a foam with the desired properties, such as density, stiffness, and cell content as described herein.

In some aspects, the foaming composition includes two or more foaming agents. In one example, the foaming composition includes carbon dioxide and a hydrocarbon. In another example, the foaming composition includes nitrogen and carbon oxide. In yet another example, the foaming composition includes a hydrocarbon and a chlorofluorohydrocarbon.

The foamable composition, in addition to the cyclic olefin copolymer and the foaming agent, may include at least one additional component. In one example, the additional component is a surfactant. Suitable examples of surfactants usable in the foamable compositions of the present disclosure include polysiloxanes (e.g., silicone surfactants and ethoxylated polysiloxane), ethoxylated fatty acids, salts of fatty acids, ethoxylated fatty alcohols, salts of sulfonated fatty alcohols, and fatty acid ester sorbitan ethoxylates. The foaming composition may also include a nucleating agent, a pigment, a colorant, a stabilizer, a fragrance, a flame retardant, or an odor masking agent. Such additives may assist in controlling size and amount of foam cells, and enhance stability of the foam.

Any one of the methods of making a foam described in this disclosure may include one or more of the following features. In one example, the method includes a step of melting the cyclic olefin copolymer at or above the melting temperature of the copolymer to obtain a liquid cyclic olefin copolymer melt. In some aspects, the step of combining a polymer with a foaming agent described here includes combining the liquid cyclic olefin copolymer melt with the liquefied foaming agent to obtain a liquid foamable composition. In one example, the cyclic olefin copolymer melt may be combined with liquid carbon dioxide at supercritical conditions. In certain aspects, the step of combining a polymer with a foaming agent described here includes combining the cyclic olefin copolymer in solid form with a liquid foaming agent, and then melting the copolymer to obtain a liquid foamable composition. The step of combining a polymer with a foaming agent described here may be carried out at a temperature that is at or above the melting point of the cyclic olefin copolymer. In some aspects, the temperature is from about 30° C. to about 120° C., from about 40° C. to about 110° C., or from about 50° C. to about 100° C. For example, the temperature is about 30° C., about 40° C., about 50° C., about 60° C., about 75° C., about 80° C., about 90° C., or about 100° C. The step of combining a polymer with a foaming agent described here may be carried out at a pressure that is sufficient for the foaming agent to remain in a liquefied form. In some aspects, the pressure is from about 500 psig to about 4,000 psig, or from about 1,000 psi to about 3,000 psi. For example, the pressure is about 500 psig, about 1,000 psig, about 1,500 psig, about 2,000 psig, about 2,500 psig, or about 3,000 psig. In some aspects, the foaming agent is soluble in the cyclic olefin copolymer, and the foamable composition is a homogenous liquid. As used herein the term “combining” refers to bringing the named components in contact with one another, for example, in a foaming reactor, chamber, or column, under such conditions, including temperature and pressure, that facilitate physical contact between the components. In one example, the step of foaming the composition containing a cyclic olefin copolymer and a foaming agent to produce a foam can be carried out using any of the methods known in the foaming industry. Methods, tools, and apparatuses that may be used in the methods of the present disclosure are described, for example, in PCT publication No. 2018/182906, PCT publication No. 2018/182906, and U.S. Pat. No. 9,834,654, which are incorporated herein by reference in their entirety. In some aspects, the step of foaming the composition is carried out using a pressure-drop technique. In this method, the pressure above the foamable composition is released such that to create a homogeneous pressure drop to atmospheric pressure. During this pressure drop time period, the liquid foaming agent in the composition vaporizes, turns into gas, and expands, thereby creating plurality of bubbles, or cells, within the cyclic olefin copolymer composition. In some aspects, the step of foaming the composition is performed at a pressure drop rate in a range from about 1 MPa/s to about 60 MPa/s.

In some aspects of the present methods, the following holds: the foaming agent includes a liquefied carbon dioxide; combining the cyclic olefin copolymer and the carbon dioxide is performed at a pressure in a range from about 1,000 psi to about 3,000 psi and at a temperature at or above the melting temperature of the polymer; the carbon dioxide is soluble in the polymer; the composition is a homogenous liquid; and foaming is performed using a pressure-drop technique at a pressure drop rate in a range from about 1 MPa/s to about 60 MPa/s.

In a general aspect, the present disclosure also provides various foams. For example, the disclosure provides a foam prepared by any one of the methods described herein. In some aspects, the foam includes a cyclic olefin copolymer as disclosed in this application, such as cyclic olefin copolymer containing cyclic olefin monomer units in an amount from about 0.5 mol. % to about 50 mol. % based on the total amount of monomer units in the copolymer. In some aspects, the density of the foam is no greater than about 0.1 g/cm³, about 0.12 g/cm³, or about 0.15 g/cm³, as determined using a density kit according to ASTM D792 protocol. For example, the density of the foam is from about 0.1 g/cm³ to about 0.7 g/cm³. The cell density of the foam may be from about 10⁵ cells/cm³ to about 10⁹ cells/cm³, as determined, for example, using scanning electron microscope according to a protocol described in Wang et al., Chem. Eng. J. 327 (2017) 1151-1162 and Tram et al., SPE ANTEC™ Indianapolis (2016) 1870-1881. The cell count of the foam may be from about 10³ to about 10⁶ cells/cm², as determined, for example, using an optical microscope or a scanning electron microscope (SEM) and a carefully fractured or sliced foam sample cross-section. The average size of the cells of the foam may be from about 1 μm to about 200 μm, from about 10 μm to about 100 μm, or from about 25 μm to about 85 μm, as determined, for example, using an optical microscope or a scanning electron microscope (SEM). For example, the average size of the cells of the foam may be about 10 μm, about 20 μm, about 25 μm, about 40 μm, about 50 μm, about 75 μm, or about 100 μm. The cell count and cell size can be determined, for example, according to ASTM D3576-98 protocol. In some aspects, the closed cell content of the foam is at least 50% based on the total amount of cells in the foam, as determined, for example, using pycnometer according to ASTM D6226 protocol. For example, the closed cell content of the foam can be from about 50% to about 90%. In such aspects, the foam is rigid. In certain aspects, the amount of open cells in the foam is greater than the amount of closed cells. In such aspects, the foam is flexible (or resilient). In some aspects, thermal diffusivity of the foam may be from about 0.1 mm²/s to about 0.3 mm²/s (such as, for example 0.2 mm²/s), and/or the thermal conductivity of the foam is no greater than about 0.07 W/(m×K), as determined, for example, using a thermal constants analyzer according to ISO 22007-2 protocol. In some aspects, the specific heat value of the foam is from about 0.2 MJ/m³K to about 0.4 MJ/m³K. In some aspects, the foam possesses excellent flammability characteristics. For example, the burning time of the foam is no greater than 8 seconds, or no greater than 5 seconds (e.g., 0 seconds, 1 second, 2 seconds, or 3 seconds), as determined, for example, according to ASTM D3801 protocol.

In some aspects, the foam has one or more of the following properties: a density of from about 0.1 g/cm³ to about 0.7 g/cm³; a closed cell content of at least 50%; a thermal diffusivity of from about 0.1 mm²/s to about 0.3 mm²/s; and a specific heat value of from about 0.2 MJ/m³K to about 0.4 MJ/m³K.

In some aspects, the following holds: the density of the foam is no greater than 0.15 g/cm³; the flammability of the foam, as measured by burning time, is from about 2 seconds to about 5 seconds; the cell density of the foam is from about 10⁵ cells/cm³ to about 10⁹ cells/cm³; the cell count of the foam is from about 10³ to about 10⁶ cells/cm²; the closed cell content of the foam is from about 50% to about 90%; the thermal conductivity of the foam is no greater than about 0.07 W/(m×K); the thermal diffusivity of the foam is about 0.2 mm²/s; and the specific heat value of the foam is from about 0.2 MJ/m³K to about 0.4 MJ/m³K.

Foams of the present disclosure can be used in any application or industry where foams are desired. For example, the foams can be used for molding and/or extrusion, for making consumer goods, industrial goods and tools, construction materials, vibration dampening materials, sound isolation materials, void fills, braces, thermal insulation materials, packaging materials, and automotive parts. Examples of articles that can be prepared from the foams of the present disclosure include soft packaging, rigid packaging, recreation equipment, tubing, structural foam, electrical insulation, buoyancy aid, insulation spray foam, seat cushions, toys, fire protectant sheets, and various household items. The foams can have any desirable configuration, for example, a sheet, a plank, a slab, a block, or any desired molded shape.

### EXAMPLES

### Materials and Sample Preparation

A cyclic olefin copolymer (TOPAS™ E-140) used for foam preparation is commercially available from TOPAS Advanced Polymers. The properties of this polymer are given in Table 1.

TABLE 1
Characteristics of TOPAS ™ E-140 COC

| property | value |
|---|---|
| norbomene monomer content | 11 mol. % (30 wt. %) |
| T_{g} | −1° C. |
| Tₘ | 84° C. |
| viscosity at 80° C. | 300 kPa × s |

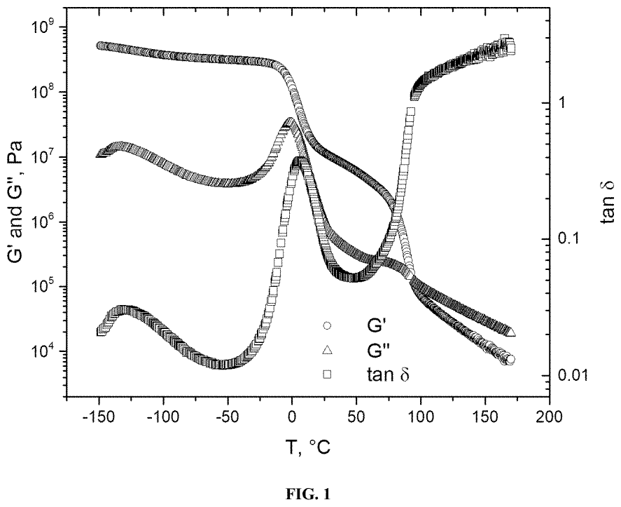

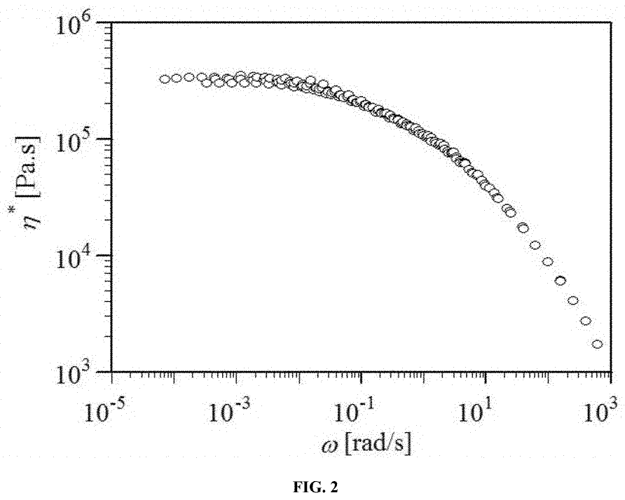

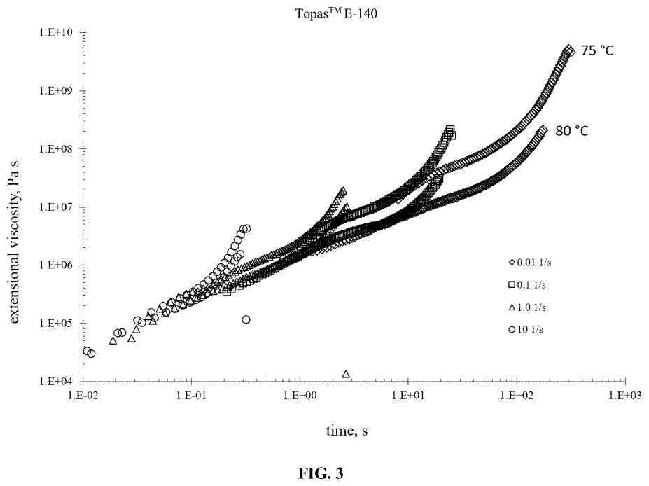

Dynamical mechanical analysis, complex shear viscosity, and transient extensional viscosity of TOPAS™ E-140 COC are shown in FIGS. 1, 2, and 3, respectively. A shear rheology of the TOPAS™ E-140 COC sample near its melting temperature (about 80° C.) (FIG. 2) showed significant shear-thinning, demonstrating good processability in extrusion operations. Under extensional flow, the TOPAS' E-140 COC sample showed significant strain hardening (FIG. 3), which is desired for good foam formation and stability. The viscosity of the samples was determined using an ARES-G2 rheometer (TA Instruments) with 25 mm parallel plates geometry. Dynamic frequency sweeps were performed in the frequency range of 0.01 to 100 Hz and a strain amplitude of 10% at 190° C. Elastic modulus (G′) and the viscous modulus (G″) of the tested polymer sample were measured. The viscosity of the polymer sample is determined as a square root of the sum of (G′)² and (G″)². The viscosity values of interest are those measured at the lowest frequency during the frequency sweep. The number-average molecular weight (Mₙ), size-average molecular weight (M_{Z}), and weight-average molecular weight (M_{W}) of the cyclic olefin copolymer were determined using gel permeation chromatography (GPC-3D) multi-angle light scattering (MALLS) method. Size-exclusion chromatography (SEC), also known as gel permeation chromatography (GPC), was performed using a high temperature size-exclusion chromatograph (commercially available from either from Waters Corporation or Polymer Laboratories) with a differential refractive index detector (DRI), an online light scattering detector, a viscometer (SEC-DRI-LS-VIS), and a multi-angle light scattering detector (MALLS), where mono-dispersed polystyrene was used as the standard in all cases. The Mark-Houwink constants used were K, equal to 0.00070955 dL/g, and a, equal to 0.65397, as determined for ethylene propylene diene monomer rubber (EPDM) with 0 wt. % propylene. Three Polymer Laboratories PLgel 10 mm MIXED-B columns were used. The nominal flow rate was 0.5 cm³/min and the nominal injection volume was 300 μL. The various transfer lines, columns and differential refractometer (the DRI detector) were kept in an oven maintained at 135° C. Solvent for the SEC experiment was prepared by dissolving 6 grams of butylated hydroxy toluene (an antioxidant) in 4 liters of reagent grade 1,2,4-trichlorobenzene (TCB). The TCB solvent mixture was then filtered through a 0.7 μm glass pre-filter and subsequently through a 0.1 μm TEFLON™ filter. The TCB was then degassed using an online degasser before entering the SEC.

The linear low-density polyethylene (LLDPE) polymer sample (HES-1003 NT7) and polypropylene (PP) polymer sample (WB140) were obtained from The Dow Chemical Company and Borealis, respectively.

Prior to using in foaming experiments, the polymer resins were compression-molded to disk shape samples 3 mm thick with a hot press at about 200° C. after breaking the extrudates into smaller pieces or pellets. Upon pressure release, the molded samples were immediately cooled in a large reservoir of water at about 13° C.

The melting temperatures (Tₘ), glass transition temperatures (T_{g}), and crystallization temperatures (T_{c}) of all polymers were measured using high pressure differential scanning calorimeter (HP-DSC) DSC 204 HP Phoenix Differential Scanning calorimeter (Netzsch) according to the following procedure. After the sample was installed, the system was vacuumed for 5 min. Each sample was heated from room temperature (ca. 23° C.) during a first heating cycle at a constant heating rate of 10° C./min to 200° C. during 10 min time period in order to erase the thermal history of the polymer, held for approximately 3-5 minutes, then cooled at a constant cooling rate of 10° C./min to 20° C., held for approximately 3-5 minutes, then reheated at a constant heating rate of 10° C./min to 200° C. for a second heating cycle. During the cooling and heating processes, the crystallization and melting patterns of the samples were recorded. The melting temperature, glass transition temperature, and crystallization temperature were determined based on the second heating cycle in the DSC thermogram. DSC scan were obtained in J/g.

The blowing agent used in the foaming experiments was CO₂ (99.8% pure, supplied by Airgas).

### Foaming Chamber and General Protocol for the Foaming Process

The foams were generated from polymer samples (TOPAS™ E-140 COC, LLDPE, and DAPLOY™ WB 140 PP) by a batch foaming process in a high temperature and pressure foaming chamber. The maximum operating temperature and pressure of the chamber were 250° C. and 4,500 psig, respectively. Pressure drop rates of 4 MPa/s, 9 MPa/s, 18 MPa/s, 35 MPa/s, and 60 MPa/s were used to make the foams. To produce a foam, a polymer sample was placed into the chamber at a test temperature, and then the chamber was closed. The chamber was then purged with CO₂ for about 30 seconds prior to pressurization. In the next step of the process, the chamber was pressurized with CO₂ up to the test pressure while maintaining the test temperature (allowing CO₂ to diffuse into the molten polymer sample). After two hours of mixing time at the test parameters, pressure valve was quickly opened to induce foaming. The resultant foam was cooled with cold water.

### Methods for Characterizing Foams

Various properties of foam samples prepared from TOPAS' E-140 COC were determined (an average value was taken over three-time measurements). Table 2 summarizes the properties, as well as apparatuses and base protocols that were used to determine these properties. Where any one of the properties described in these Examples is referenced in the appended claims, it is to be measured in accordance with the specified test procedure of these Examples unless otherwise specified.

TABLE 2
Measured properties, apparatuses, and protocols

| Property | Apparatus | Protocol Basis |
|---|---|---|
| foam density/specific | Balance with density kit | ASTM D792 |
| volume cell density | EVOS AMG Microscope, Scanning | Wang et al.¹ |
| | Electron Microscope (SEM) | Tram et al.² |
| phase transitions | High Pressure Differential Scanning | ASTM E794 |
| | Calorimeter (HP-DSC); X-Ray | |
| | Scattering | |
| open/closed cell | StereoPycnometer | ASTM D6226 |
| contents | | |
| flammability | Stand, torch, timer | ASTM D3801 |
| cell count/cell size | Optical microscope or SEM | ASTM |
| | | D3576-98 |
| thermal | Transient plane heat source | ISO 22007-2 |
| conductivity/ | (hot disk) | |
| diffusivity/heat | | |
| capacity | | |

¹Wang et al., Chem. Eng. J. 327 (2017) 1151-1162;
²Tram et al., SPE ANTECTM Indianapolis (2016) 1870-1881.

The density (φ and the specific volume (\hat{ν}) of a solid foam sample were calculated using the following equations, where W is the weight and V is the volume of the sample:

ρ=W/V

\hat{ν}≡1/ρ

The volume of irregularly shaped foam samples was determined by Archimedes principle, by measuring buoyancy force upon submerging the foam sample into water. According to Archimedes principle, density of the foam sample can be determined according to the following equation, where ρ₀ is the density of water at the test temperature and W_{B} is apparent immersed weight:

$$ρ = {ρ}_{0} \frac{W}{\vert W - {W}_{B} \vert}$$

HP-DSC analysis of the foam samples was performed in the DSC 204 HP Phoenix Differential Scanning calorimeter, with the following procedure applied for every measurement. After the sample was installed, the system was vacuumed for 5 min. Each sample was heated during a first heating cycle from room temperature (ca. 23° C.) at a constant heating rate of 10° C./min to 200° C. during 10 min time period in order to erase the thermal history of the polymer, held for approximately 3-5 minutes, then cooled at a constant cooling rate of 10° C./min to 20° C., held for approximately 3-5 minutes, then reheated at a constant heating rate of 10° C./min to 200° C. for a second heating cycle. During the cooling and heating processes, the crystallization and melting patterns of the samples were recorded. The degree of crystallinity was determined based on the second heating cycle in the DSC thermogram. DSC scan were obtained in J/g. Thermal conductivity, thermal diffusivity, heat values of the foam samples were determined according to ISO 22007-2 protocol (Plastics-determination of thermal conductivity and thermal diffusivity, Part 2; Transient plane heat source (hot disc) method). The test was performed using thermal constants analyzer TPS 2200 (Hot Disk).

The cell density (CD), the number of cells (bubbles) per the volume of the polymer prior to foaming, is obtained using the following equation, where A is the area (cm²) of the microscope image of the foam, n is the number of cells in the image, ρ_{soiid} is the density of the polymer prior to foaming, and ρ is the density of the foam sample:

CD=(n/A)^{1.5}(ρ_{solid}/ρ)

The cell count and cell size of the foam were determined using an optical microscope or a scanning electron microscope (SEM) and a carefully fractured or sliced foam sample cross-section according to ASTM D3576-98 protocol. Optical microscope (Dino-Lite AM2111) or a scanning electron microscope (JEOL 6060) were used for these measurements. The cell size was estimated by assuming that the foams were isotropic with a uniform distribution of spherical bubbles in all directions.

A pycnometer (SPY-6DC) was used to determine closed cell and open cell contents of the foam samples. The sample volume (V) consists of three components:

V=V_{solid}+V_{closed}+Vₒₚₑₙ

where V_{solid}, V_{closed}, and Vₒₚₑₙ are volume of the solid polymer matrix of the foam, total volume of closed cells, and total volume of open cells, respectively. V was determined by Archimedes principle as described above. To determine the Vₒₚₑₙ, the foam sample was placed in a chamber of the pycnometer, the chamber was then evacuated and back-filled with nitrogen gas. The volume of the nitrogen gas flowing into the chamber was measured. This volume corresponds to the combined volume of all open cells in the foam sample (Vₒₚₑₙ). V_{solid} was determined using the following equation, where W and ρ_{solid} were determined as described above:

V_{solid}=W/ρ_{solid}

Hence, V_{closed} was calculated according to the following equation:

Vclosed=V−(Vsolid+Vopen)

The open and closed cell content in the foam sample (f) can be determined according to the following equations:

f_{closed (%)}=100×V_{closed}/V

f_{open (%)}=100×Vₒₚₑₙ/V

For determination of flammability of the foam samples, a burning time method was used. A foam sample of 1 cm (W)×1.5 cm (L)×0.3 cm (H) was held vertically in a fume hood. A 7 cm-long torch flame was applied to the end of the foam sample for 3 seconds and then removed. The burning time (a time during which a flame on the sample was visible observed) was recorded.

### Example 1—Foam Sample Prepared from TOPAS™ E-140 COC Using CO₂ at a Pressure of 1,000 Psig

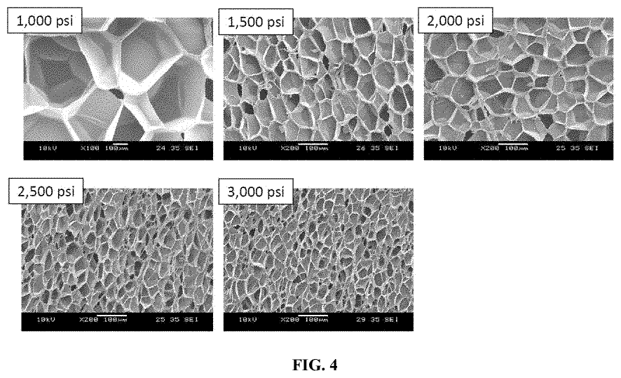

The foaming of TOPAS™ E-140 COC was carried out using a batch foaming chamber according to the general protocol at a temperature in a range between 75° C. and 80° C. As a foaming agent, CO₂ was used in supercritical conditions at 1,000 psi. Pressure release rate (dP/dt) was 12 MPa/s. FIG. 4 contains a SEM micrograph illustrating the cell morphology of TOPAS™ E140 foam sample produced at CO₂ pressure of about 1,000 psi.

### Example 2—Foam Sample Prepared from TOPAS™ E-140 COC Using CO₂ at a Pressure of 1,500 Psig

The foaming of TOPAS™ E-140 COC was carried out using a batch foaming chamber according to the general protocol at a temperature in a range between 75° C. and 80° C. As a foaming agent, CO₂ was used in supercritical conditions at 1,500 psi. Pressure release rate (dP/dt) was 16 MPa/s. FIG. 4 contains a SEM micrograph illustrating the cell morphology of TOPAS™ E140 COC foam sample produced at CO₂ pressure of about 1,500 psi.

### Example 3—Foam Sample Prepared from TOPAS™ E-140 COC Using CO₂ at a Pressure of 2,000 Psig

The foaming of TOPAS™ E-140 COC was carried out using a batch foaming chamber according to the general protocol at a temperature in a range between 75° C. and 80° C. As a foaming agent, CO₂ was used in supercritical conditions at 2,000 psi. Pressure release rate (dP/dt) was 19 MPa/s. FIG. 4 contains a SEM micrograph illustrating the cell morphology of TOPAS™ E140 foam sample produced at CO₂ pressure of about 2,000 psi.

### Example 4—Foam Sample Prepared from TOPAS™ E-140 COC Using CO₂ at a Pressure of 2,500 Psi

The foaming of TOPAS™ E-140 COC was carried out using a batch foaming chamber according to the general protocol at a temperature in a range between 75° C. and 80° C. As a foaming agent, CO₂ was used in supercritical conditions at 2,500 psi. Pressure release rate (dP/dt) was 26 MPa/s. FIG. 4 contains a SEM micrograph illustrating the cell morphology of TOPAS™ E140 COC foam sample produced at CO₂ pressure of about 2,500 psi.

### Example 5—Foam Sample Prepared from TOPAS™ E-140 COC Using CO₂ at a Pressure of 3,000 Psig

The foaming of TOPAS™ E-140 COC was carried out using a batch foaming chamber according to the general protocol at a temperature in a range between 75° C. and 80° C. As a foaming agent, CO₂ was used in supercritical conditions at 3,000 psi. Pressure release rate (dP/dt) was 33 MPa/s. FIG. 4 contains a SEM micrograph illustrating the cell morphology of TOPAS™ E140 COC foam sample produced at CO₂ pressure of about 3,000 psi. The mean cell diameter of the foam sample prepared in Example 5 was approximately 50 μm. The foam density and the cell density of the foam sample obtained in Example 5 were 0.097 g/cm³ and 10⁸ cells/cm³, respectively. The foam obtained in example 5 was characterized as a low-density foam that is comparable to the microcellular foams obtained with commercial materials like LLDPE and polypropylene.

### Example 6—Properties of TOPAS™ E140 COC Foam Samples Obtained in Examples 1-5

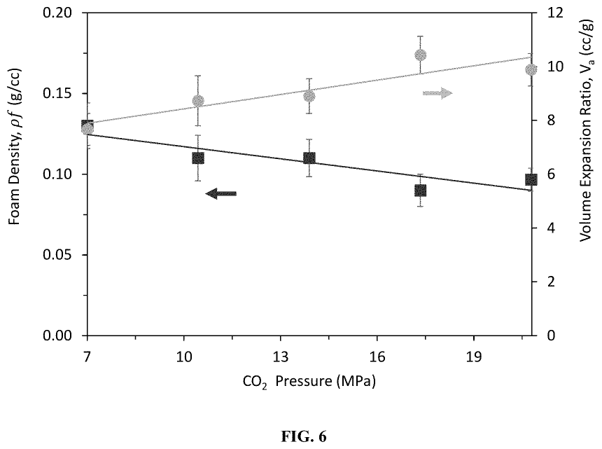

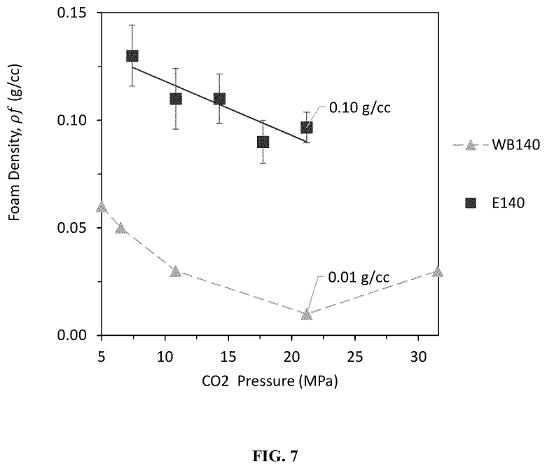

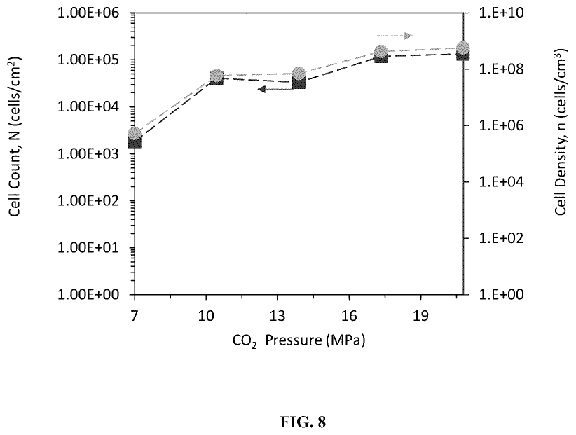

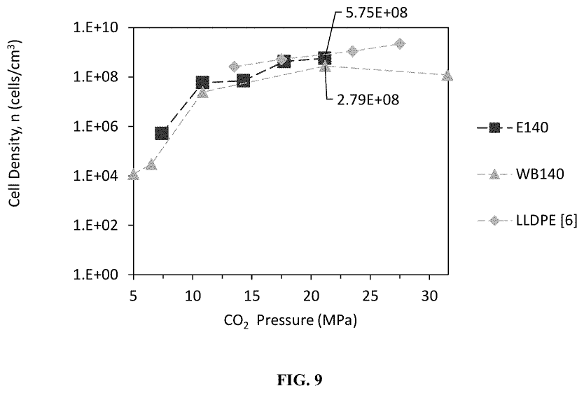

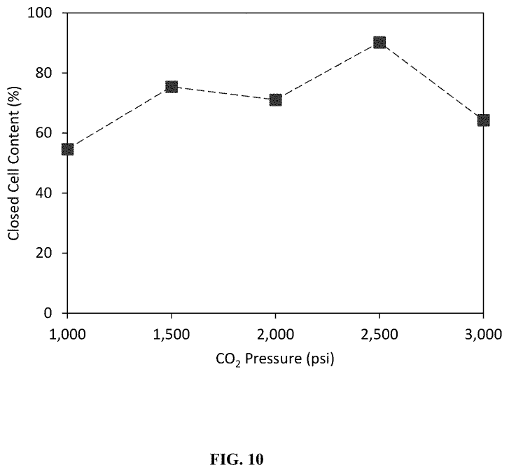

The properties of the foam samples prepared in Examples 1-5 are shown in FIGS. 6-10 (showing foam properties such as foam density, cell count and density, and open/closed cell content).

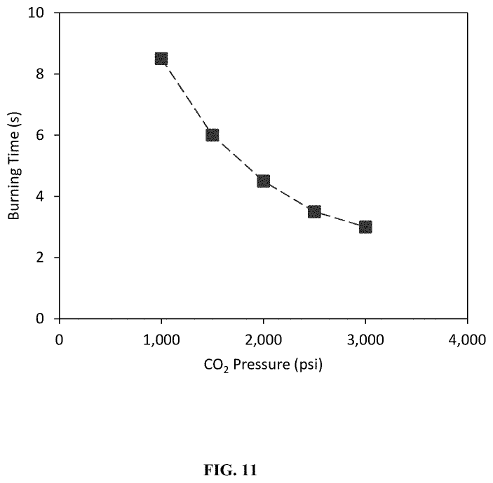

The results of flammability evaluation of foam samples obtained in Examples 1-5 are shown in FIG. 11 (burning time after ignition and removing fire). These results show that the desirably poor flammability (short burning times) can be achieved in COC foams.

Table 3 summarizes the properties of the foams obtained in Examples 1-5.

TABLE 3

| | 1 | 2 | 3 | 4 | 5 |
|---|---|---|---|---|---|
| Foam density | 0.13 | 0.11 | 0.12 | 0.09 | 0.10 |
| (g/cm³) | | | | | |
| Volume expansion | 7.7 | 8.7 | 8.9 | 10.2 | 9.5 |
| ratio, cm³/g | | | | | |
| Cell count, cells/cm² | 1.5 × 10³ | 4 × 10⁴ | 3.5 × 10⁴ | 1 × 10⁵ | 1 × 10⁵ |
| Cell density, | 1 × 10⁶ | 1 × 10⁸ | 1 × 10⁸ | 2 × 10⁸ | 2 × 10⁸ |
| cells/cm³ | | | | | |
| Closed cell | 55 | 75 | 71 | 90 | 64 |
| content, % | | | | | |
| Burning time, s | 8.5 | 6 | 4.5 | 3.5 | 3 |

### Example 7—Crystallinity of TOPAS™ E140 COC Foam Samples Obtained in Examples 1-5

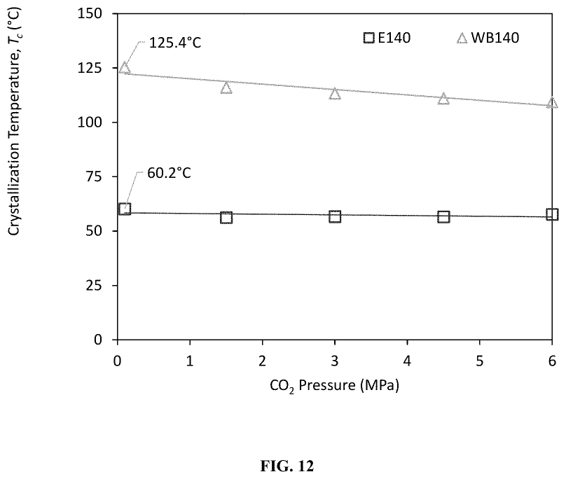

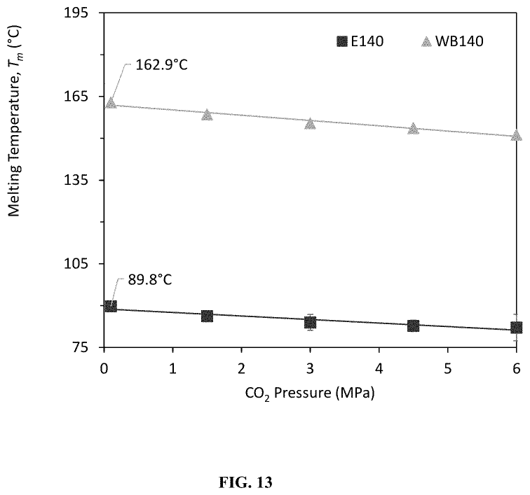

The effect of CO₂ pressure on the crystallization behavior of TOPAS™ E140 COC was analyzed based on the crystallization temperature and melting temperature of foam samples obtained in Examples 1-5. The results of crystallization experiments were summarized in FIGS. 12 and 13. As the FIGS. 12 and 13 also show, the TOPAS™ E140 COC foams were also compared to foam samples prepared from DAPLOY™ WB 140 PP under otherwise identical conditions. Melting and crystallization temperatures of foam samples of Examples 1-5 were found to be lower than these temperatures of the corresponding DAPLOY™ WB 140 samples under the same conditions. Because reduced crystallinity produces softer foams, these results show that foams prepared from TOPAS™ E140 COC can be used for soft (flexible) foam applications.

### Example 8—Thermal Properties of TOPAS™ E140 COC Foam Samples Obtained in Examples 2 and 5

Thermal conductivity, thermal diffusivity, and specific heat values of foam samples prepared in Examples 2 and 5 are shown in Table 4.

TABLE 4
Thermal conductivity, thermal diffusivity, and specific heat
values of raw COC polymer and foams prepared from COC polymer.

| | | Thermal | Thermal | |
|---|---|---|---|---|
| | Temperature | conductivity (W/ | diffusivity | Specific Heat |
| Sample | (° C.) | mK) | (mm²/s) | (MJ/m³K) |
| raw COC | 20 | 0.12-0.15 | N/A | N/A |
| foam sample | 23.2 | 0.06746 | 0.1977 | 0.3412 |
| (Example 5) | | | | |
| foam sample | 23.2 | 0.05934 | 0.1996 | 0.2973 |
| (Example 2) | | | | |

The results presented in Table 4 show poor thermal conductivity of the COC foams, reaching a low value of 0.06 W/mK. Poor thermal conductivity leads to superior thermal insulation properties of foams prepared from COC polymers.

### Example 9—Comparison of COC Foams with LLDPE and PP Foams

The differences in properties between foams obtained from TOPAS™ E140 COC, DAPLOY™ WB 140 PP (commercially available from Borealis AG) and TUFLIN™ HES-1003 NT 7 LLDPE (commercially available from The Dow Chemical Company) are summarized in Table 5.

TABLE 5
General comparison between foam samples

| | BOREALIS PP, | DOW LLDPE, | |
|---|---|---|---|
| | DAPLOY ™ WB | TUFLIN ™ HES- | TOPAS ™ E-140 |
| Material Property | 140 | 1003 NT 7 | COC |
| Melting and | High melting and | Relatively high | Low melting and |
| Crystallization | crystallization | melting and | crystallization |
| Temperatures, Tₘ | temperatures (Tₘ = | crystallization | temperatures (Tₘ = |
| and T_{c} | 162.9° C., T_{c} = | temperatures (Tₘ = | 89.8° C., T_{c} = 60.2° C., |
| | 125.4° C., at Pₐₜₘ) | 122° C., T_{c} = 115° C., at | at Pₐₜₘ) |
| | | Pₐₜₘ) | |
| Crystallinity, % X_{c} | Higher crystallinity, | N/A | Lower crystallinity, |
| | (X_{c} = 51.16%) | | (X_{c} = 18.83%) |
| Foam Density, ρ_{f} | Lower density, (ρ_{f} = | N/A | Higher density, (ρ_{f} = |
| | 0.01 g/cm³) | | 0.09 g/cm³) |
| Cell density, n | Lower cell density, | Higher cell density, | Higher cell density, |
| | (n = 2.79 × 10⁸ | (n = 5.75 × 10⁸ | (n = 5.75 × 10⁸ |
| | cells/cm³) | cells/cm³) | cells/cm³) |
| Open/closed cell | N/A | N/A | No apparent trend |
| content | | | with CO₂ pressure |
| Flammability, | N/A | N/A | Desirable inferior |
| Burning time t | | | flammability |
| | | | achieved at high |
| | | | CO₂ P. |

### Other Embodiments

It is to be understood that while the present application has been described in conjunction with the detailed description thereof, the foregoing description is intended to illustrate and not limit the scope of the present application, which is defined by the scope of the appended claims. Other aspects, advantages, and modifications are within the scope of the following claims.

1. A method comprising:
(i) combining a polymer with a foaming agent to produce a composition; and
(ii) foaming the composition to produce a foam,
wherein the polymer comprises cyclic olefin monomer units in an amount of from about 0.5 mol. % to about 50 mol. % based on the total amount of monomer units in the polymer.

2. A composition comprising:
a polymer comprising cyclic olefin monomer units in an amount of from about 0.5 mol. % to about 50 mol. % based on the total amount of monomer units in the polymer;
and, optionally, a foaming agent,
wherein the composition is a foam.

3. The composition of claim 2, wherein the polymer comprises cyclic olefin monomer units in an amount of from about 1 mol. % to about 30 mol. % based on the total amount of monomer units in the polymer.

4. The composition of claim 2, wherein the cyclic olefin monomer comprises at least one member selected from the group consisting of norbornene, tetracyclododecene, cyclopentene, dicyclopentadiene, ethylidene norbornene, vinyl norbornene, cyclooctene, and cyclooctadiene.

5. The composition of claim 2, wherein the polymer comprises at least one ethylene monomer.

6. The composition of claim 2, wherein the polymer comprises at least one α-olefin monomer selected from the group consisting of 1-propene, 1-butene, 1-hexene, and 1-octene.

7. The composition of claim 2, wherein the polymer is branched.

8. The composition of claim 2, wherein the polymer comprises a monomer comprising a polar functional group.

9. The composition of claim 8, wherein the polar functional group comprises at least one member selected from the group consisting of hydroxy, aldehyde, acid, amine, amide, anhydride, and urea.

10. The composition of claim 2, wherein the polymer is amorphous.

11. The method composition of claim 2, wherein the polymer is semi-crystalline.

12. The composition of claim 2, wherein the polymer has one or more of the following properties:
a highest glass-transition temperature (T_{g}) of from about −80° C. to about 80° C. at atmospheric pressure;
a melting temperature (Tₘ) of from about 30° C. to about 120° C. at atmospheric pressure; and
a melt index, measured at 230° C./2.16 kg, of from about 0.1 g/min to about 50 g/min at atmospheric pressure.

13. The composition of claim 2, wherein the foaming agent comprises a liquefied gas.

14. The composition of claim 2, wherein the foaming agent comprises at least one member selected from the group consisting of carbon dioxide, nitrogen, a hydrocarbon, and a chlorofluorocarbon.

15. The composition of claim 14, wherein the foaming agent comprises at least one hydrocarbon selected from the group consisting of propane, butane, propene, butene, isobutene, pentane, hexane, and heptane.

16. The composition of claim 14, wherein the foaming agent comprises at least one chlorofluorocarbon selected from the group consisting of trichloethylene, dichloroethane, trichlorofluoromethane, dichlorodifluoromethane, 1,2,2-thrichlorothrifluoroehtane, and dichlorotetrafluoroethane.

17-18. (canceled)

19. The composition of claim 2, wherein the foaming agent is soluble in the polymer.

20-21. (canceled)

22. The composition of claim 2, wherein the foam has one or more of the following properties:
a density of from about 0.1 g/cm³ to about 0.7 g/cm³;
a closed cell content of at least 50%;
a thermal diffusivity of from about 0.1 mm²/s to about 0.3 mm²/s; and
a specific heat value of from about 0.2 MJ/m³K to about 0.4 MJ/m³K.

23. The composition of claim 2, wherein the foam is rigid.

24. The composition of claim 2, wherein the foam is resilient.

25. (canceled)
